(19) United States
(12) Patent Application Publication
(10) Pub. No.: US 2009/0189742 A1
(43) Pub. Date: Jul. 30, 2009

(54) Radio communication device and radio communication system

(75) Inventor: Hiroshi Watanabe, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/148,797

(22) Filed: Apr. 22, 2008

(30) Foreign Application Priority Data
Jan. 24, 2008 (JP) P2008-013773

(51) Int. Cl. H04Q 5/22

(52) U.S. Cl. 340/10.31

(57) ABSTRACT

According to one embodiment, a radio communication device includes: an antenna that communicates with a non-contact IC card by a radio signal having a predetermined frequency, the antenna having an unique resonance frequency in vicinity of the predetermined frequency; a frequency changer that shifts a resonance frequency of the antenna from the vicinity of the predetermined frequency to a high resonance frequency higher than the unique resonance frequency when the frequency changer is activated; a controller that controls whether or not the frequency changer is activated.

### CROSS-REFERENCE TO RELATED APPLICATIONS

This application is based upon and claims the benefit of priority from Japanese Patent Application No. 2008-013773, filed Jan. 25, 2008, the entire contents of which are incorporated herein by reference.

### BACKGROUND

1. Field

One embodiment of the invention relates to a radio communication device and a radio communication system, and more particularly to a radio communication device and a radio communication system that enable establishment of communication with a noncontact IC card.

2. Description of the Related Art

An individual identification technique utilizing radio communication (Radio Frequency Identification which will be abbreviated hereinafter as “RFID”) is widely utilized for automatic ticket gates of a railway, management of times of arrival and departure of an employee at and from a corporation or an office, various types of electronic money, and the like. In one mode of RFID, information is exchanged between a device called a reader/writer and an information medium called a noncontact IC card (hereinafter called a “card”) by means of radio communication performed therebetween. A loop antenna incorporated in the reader/writer and a loop antenna incorporated in the card are held in mutually-opposing positions in a communicable manner, whereupon the reader/writer is writable information into the card or read information from the card.

Some types of portable cellular phones are equipped with a function compatible with such RFID. The portable cellular phones were initially equipped with a card function. However, the portable cellular phones are recently equipped with a reader/writer function, as well, thereby exhibiting a few aspects of expansion of functionality and versatility of the portable cellular phones.

In the related-art RFID system, the loop antenna incorporated in the reader/writer and the loop antenna incorporated in the card constitute a resonator, and the resonance frequency of the resonator is set to an equal nominal value. However, such a setting has hitherto been known to induce a phenomenon of a failure to establish communication when the card and the reader/writer come extremely close to each other

There are two conceivable reasons for the above phenomenon. A first reason is carrier frequency dependency of a demodulation characteristic of an amplitude-shift-keyed (ASK) signal to be transmitted and received in the RFID system (see; for example, JP-A-2003-67689 (pp. 2 through 6, and FIG. 5)). More specifically, a characteristic curve of a demodulation voltage-to-carrier frequency of an ASK ON signal and a characteristic curve of a demodulation voltage-to-carrier frequency of an ASK OFF signal cross each other at a value of a certain carrier frequency. Therefore, when the value is close to a value of an actually-used carrier frequency, the ASK ON signal and the ASK OFF signal are not distinguished from each other.

A second reason is a phenomenon called a frequency split in which, when two resonators having the same resonance frequency are generally caused to come close to each other, a frequency is gradually separated, to thus generate two frequencies f1 and f2 (f1<f2) (see; for example, Kawaguchi, Kobayasi, and Ma “Study of Equivalent Circuit Display of Electromagnetic Coupling between Distributed Constant Resonators,” and Technical Research Report EMCJ2003-78/MW2003-175 of the Institute of Electronics, Information, and Communication Engineers, October 2003, and Ito, Minemura, Amano, “Relationship between a Dead Zone and a Coupling Coefficient in an HF band RFID,” General Convention B-1-143 of the Institute of Electronics, Information, and Communication Engineers, March 2007. The frequency split arises when close bonding occurs as a result of a space between the reader/writer and the card being reduced to a certain extent or more. When the value of the frequency split increases in excess of a limit, it may be the case where communication is not established between the reader/writer and the card.

The frequency split is described by reference to FIGS. 11 through 13 while taking the RFID system as an example. FIG. 11 is an example of actual measurement of a frequency characteristic of a return loss of a single card for an RFID system. A horizontal axis in FIG. 11 represents a frequency; the center of the plot corresponds to 13.56 megahertz (MHz); and one tick mark corresponds to 1 MHz. A vertical axis in FIG. 11 represents a return loss; the maximum value represents 0 dB; and one tick mark corresponds to 1 dB.

FIG. 12 shows an example of actual measurement of a frequency characteristic of a return loss of a single related-art reader/writer for an RFID system. A horizontal axis in FIG. 12 is identical with the horizontal axis shown in FIG. 11. A vertical axis in FIG. 12 represents a return loss; the maximum value corresponds to 0 dB; and one tick corresponds to 0.2 dB.

FIG. 13 is an example of actual measurement of frequency characteristics of return losses performed when the card whose single characteristic is shown in FIG. 11 and the loop antenna of the reader/writer whose single characteristic shown in FIG. 12 are brought closely to each other in a mutually-opposing manner. The horizontal axis and the vertical axis shown in FIG. 13 are identical with their counterparts in FIG. 12. In the drawings, a left resonance point represents a resonance point of the reader/writer, and a right resonance point represents a resonance point of the card. In this case, the value of the foregoing frequency split is about 5.5 MHz, and the resonance frequency of the card increases up to 18.0 MHz or thereabouts, which in turn poses difficulty in establishment of communication between the card and the reader/writer.

The related-art technique described in previously-described JP-A-2003-67689 attempts to solve the problem of defective communication arising between the card and the reader/writer induced because of the first reason, by means of a measure; namely, a decrease in set value of the unique resonance frequency of the antenna of the card (decreasing the resonance frequency to a value of 13.0±0.3 MHz with reference to a nominal value of 13.56 MHz. Refer to paragraphs “0072” and “0073” in the specification). However, the means for resolution is not in tune with the reality that a plurality of cards whose unique resonance frequencies are made nearly equal to a nominal value have already been distributed. In JP-A-2003-67689, the second reason is not taken into account.

### SUMMARY

According to one aspect of the invention, a radio communication device includes: an antenna that communicates with a non-contact IC card by a radio signal having a predetermined frequency, the antenna having an unique resonance frequency in vicinity of the predetermined frequency; a frequency changer that shifts a resonance frequency of the antenna from the vicinity of the predetermined frequency to a high resonance frequency higher than the unique resonance frequency when the frequency changer is activated; a controller that controls whether or not the frequency changer is activated.

According to another aspect of the invention, a radio communication system includes: a non-contact IC card; and a reader/writer device that establish communication with the non-contact IC cart by a radio signal having a predetermined frequency while opposing each other; wherein the reader/writer has: an antenna that has an unique resonance frequency; a frequency changer that shifts the resonance frequency from the vicinity of the predetermined frequency to a high resonance frequency higher than the unique resonance frequency when the frequency changer is activated; a controller that controls whether or not the frequency changer is activated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of a radio communication system of an embodiment;

FIG. 2A is an exemplary view showing an example connection with a loop antenna included in a radio communication device of the embodiment, and FIG. 2B is a view showing another example connection with the loop antenna included in the radio communication device of the embodiment;

FIG. 3 shows an example of actual measurement of a frequency characteristic of a return loss of a radio communication device of the embodiment and a frequency characteristic of a return loss of a noncontact IC card for an RFID system of the embodiment acquired when a loop antenna of the radio communication device and a loop antenna of the IC card are closely positioned opposite each other (a set value of a resonance frequency of a loop antenna of the radio communication device is 14 MHz);

FIG. 4 shows an example of actual measurement of a frequency characteristic of a return loss of a radio communication device of the embodiment and a frequency characteristic of a return loss of a noncontact IC card for an RFID system of the embodiment acquired when a loop antenna of the radio communication device and a loop antenna of the IC card are closely positioned opposite each other (a set value of a resonance frequency of a loop antenna of the radio communication device is 14.5 MHz);

FIG. 5 shows an example of actual measurement of a frequency characteristic of a return loss of a radio communication device of the embodiment and a frequency characteristic of a return loss of a noncontact IC card for an RFID system of the embodiment acquired when a loop antenna of the radio communication device and a loop antenna of the IC card are closely positioned opposite each other (a set value of a resonance frequency of a loop antenna of the radio communication device is 15 MHz);

FIG. 6 shows an example of actual measurement of a frequency characteristic of a return loss of a radio communication device of the embodiment and a frequency characteristic of a return loss of a noncontact IC card for an RFID system of the embodiment acquired when a loop antenna of the radio communication device and a loop antenna of the IC card are closely positioned opposite each other (a set value of a resonance frequency of a loop antenna of the radio communication device is 15.5 MHz);

FIG. 7 shows an example of actual measurement of a frequency characteristic of a return loss of a radio communication device of the embodiment and a frequency characteristic of a return loss of a noncontact IC card for an RFID system of the embodiment acquired when a loop antenna of the radio communication device and a loop antenna of the IC card are closely positioned opposite each other (a set value of a resonance frequency of a loop antenna of the radio communication device is 16 MHz);

FIG. 8 shows an example of actual measurement of a frequency characteristic of a return loss of a radio communication device of the embodiment and a frequency characteristic of a return loss of a noncontact IC card for an RFID system of the embodiment acquired when a loop antenna of the radio communication device and a loop antenna of the IC card are closely positioned opposite each other (a set value of a resonance frequency of a loop antenna of the radio communication device is 16.5 MHz);

FIG. 9 shows an example of actual measurement of a frequency characteristic of a return loss of a radio communication device of the embodiment and a frequency characteristic of a return loss of a noncontact IC card for an RFID system of the embodiment acquired when a loop antenna of the radio communication device and a loop antenna of the IC card are closely positioned opposite each other (a set value of a resonance frequency of a loop antenna of the radio communication device is 17 MHz);

FIG. 10 shows an example of actual measurement of a frequency characteristic of a return loss of a radio communication device of the embodiment and a frequency characteristic of a return loss of a noncontact IC card for an RFID system of the embodiment acquired when a loop antenna of the radio communication device and a loop antenna of the IC card are closely positioned opposite each other (a set value of a resonance frequency of a loop antenna of the radio communication device is 17.5 MHz);

FIG. 11 is an example of actual measurement of a frequency characteristic of a return loss of the noncontact IC card for the RFID system;

FIG. 12 is an example of actual measurement of a frequency characteristic of a return loss of a single related-art reader/writer for the RFID system; and

FIG. 13 shows an example of actual measurement of a frequency characteristic of a return loss of a related-art reader writer for an RFID system and a frequency characteristic of a return loss of a noncontact IC card for the RFID system acquired when a loop antenna of the reader/writer and a loop antenna of the IC card are closely positioned opposite each other.

### DETAILED DESCRIPTION

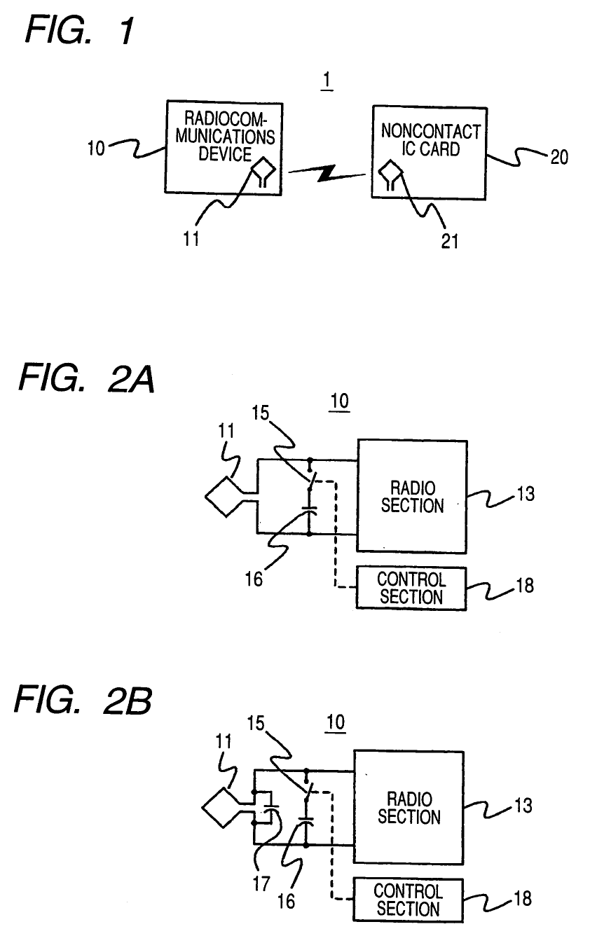

An embodiment of the present invention is described hereunder by reference to FIGS. 1 through 10. FIG. 1 is a block diagram showing the configuration of a radio communication system 1 of the embodiment of the present invention. The radio communication system 1 has a radio communication device 10 and a noncontact IC card 20. The radio communication system 1 is embodied as an individual identification system utilizing a radio frequency of; for example, 13.56 megahertz (MHz) or a frequency in the vicinity thereof (an RFID), and the radio communication device 10 is embodied as a portable cellular phone having a built-in reader/writer function for an RFID system. Moreover, the radio communication device 10 sets, in a switchable manner, the card function and the reader/writer function for the RFID system. The radio communication device is used as a card in some occasions and used as a reader/writer in other occasions.

The radio communication device 10 has a built-in loop antenna 11. The noncontact IC card 20 incorporates a loop antenna 21. The radio communication device 10 establishes communication with the noncontact IC card 20 while the loop antenna 11 is positioned opposite the loop antenna 21. Here, the term “communication” includes exchange of information, such as writing of information into an information medium typified by the RFID system or reading of information from the information medium.

FIG. 2A is a view showing an example connection of the radio communication device 10 with the loop antenna 11. A radio section 13 incorporated in the radio communication device 10 is connected to the loop antenna 11 and feeds power to the loop antenna 11. A reactance element 16 connected in series to a switching element 15 is connected in shunt with the radio section 13 in the loop antenna 10. A control section 18 incorporated in the radio communication device 18 controls opening/closing of the switching element 15.

The unique resonance frequency of the loop antenna 11 is assumed to be set to a frequency of 13.56 MHz, which is a predetermined frequency of the RFID system, or a frequency in the vicinity thereof. As a result of; for example, the radio communication device 10 being operated by way of unillustrated operation input means, the control section 18 switches between the function of the radio communication device 10 serving as a noncontact IC card of the RFID system and the function of the radio communication device 10 serving as a reader/writer of the RFID system. When the radio communication device 10 is used as a noncontact IC card, the control section 18 brings the switching element 15 into a closed position. When the radio communication device 10 is used as a reader/writer, the control section 18 brings the switching element 15 into an open position.

FIG. 2B is a view showing another example connection of the radio communication device 10 with the loop antenna 11. A difference between FIGS. 2A and 2B lies in addition of a reactance element 17 to be connected in shunt with the loop antenna 11. In other respects, the configuration of the connection is identical with that shown in FIG. 2A, and hence the configuration is provided with the same reference numerals.

In FIG. 2B, constants of the reactance elements 16 and 17 are selected in such a way that resonance is achieved at an operating frequency (e.g., 13.56 MHz) as a result of the reactance elements being connected in shunt with the loop antenna 11. When the radio communication device 10 is used as a noncontact IC card, the control section 18 brings the switching element 15 into a closed position. When the radio communication device 10 is used as a reader/writer, the control section 18 brings the switching element 15 into an open position.

By means of the configuration and the connection mentioned above, when the radio communication device 10 is used as the noncontact IC card, the loop antenna 11 effects resonance at the foregoing unique resonance frequency. When the radio communication device 10 is used as a reader/writer, the reactance element 16 is brought into an unconnected state. Therefore, the loop antenna effects resonance a frequency which is higher than the unique resonance frequency. A value of a frequency that is higher than the unique resonance frequency is selectively set by means of a constant value of the reactance element 16.

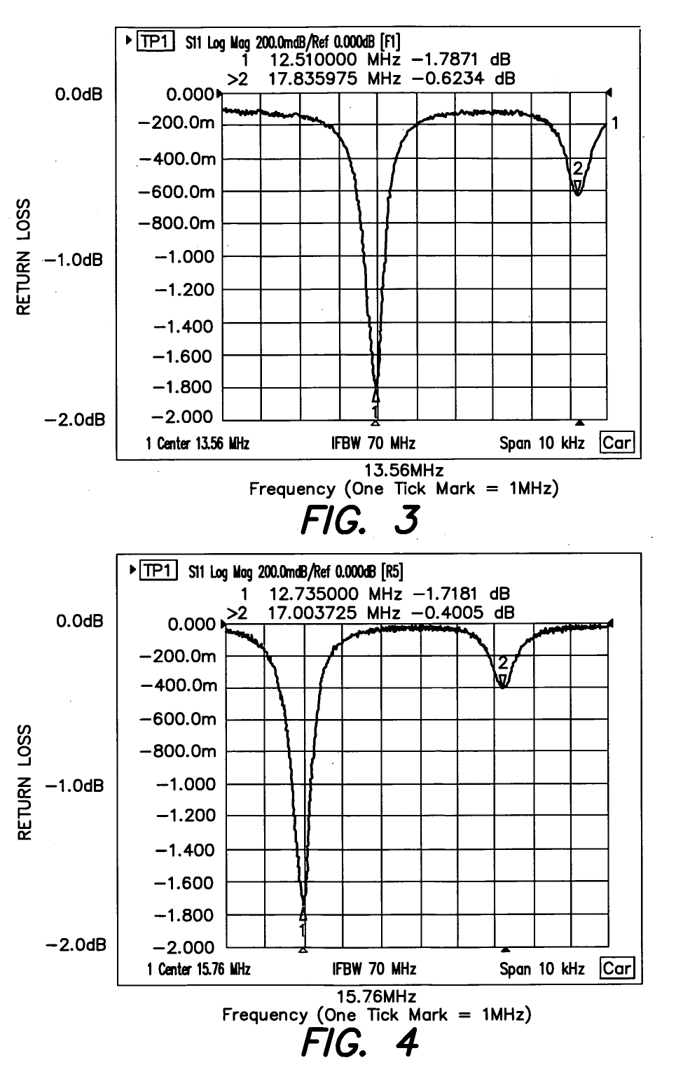

FIGS. 3 through 10 show examples of actual measurement of a frequency characteristic of a return loss of the loop antenna 11 of the radio communication device 10 and a frequency characteristic of a return loss of the loop antenna 21 of the noncontact IC card 20 achieved when the loop antennas are closely positioned opposite each other while a set value of the resonance frequency of the loop antenna 11, which is achieved when the radio communication device 10 is used as a reader/writer, is taken as a parameter.

A set value of the resonance frequency of the loop antenna 11 shown in FIG. 3 is 14 MHz. A horizontal axis in FIG. 3 represents a frequency; the center is located at 13.56 MHz; and one tick mark corresponds to 1 MHz. In FIG. 3, a vertical axis represents a return loss; the maximum value of the return loss is 0 decibel (dB); and one tick mark corresponds to 0.2 dB. A left resonance point in the drawing represents a resonance point of the loop antenna 21, and a right resonance point in the drawing represents a resonance point of the loop antenna 11.

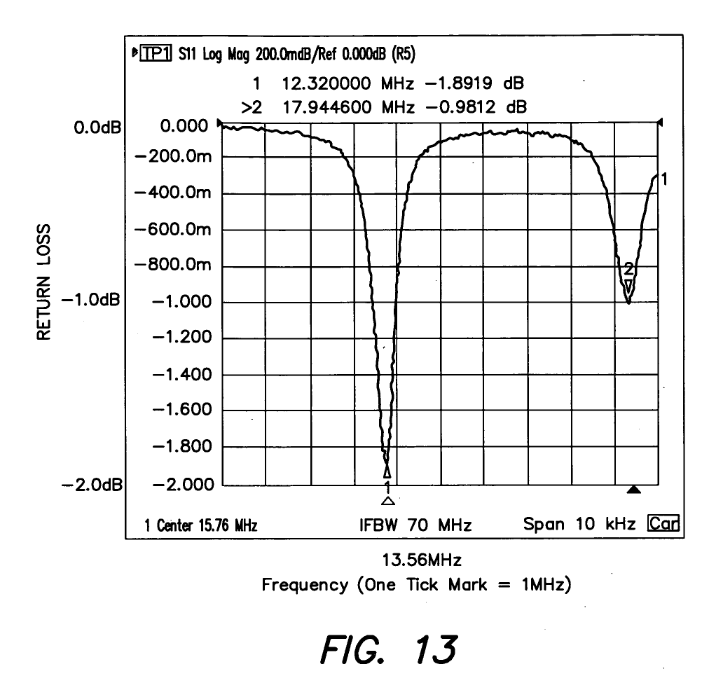

As shown in FIG. 3, the resonance point of the loop antenna 21 achieved when the resonance frequency of the loop antenna 11 is set to 14 MHz and when the loop antenna 11 is closely positioned opposite the loop antenna 21 falls below the predetermined frequency (13.56 MHz) because of occurrence of a frequency split. However, by virtue of an effect induced as a result of the resonance frequency of the loop antenna 11 being made higher than the predetermined frequency, a drop in resonance point has remained at about 12.5 MHz. Therefore, a difference between the resonance frequency and the predetermined frequency becomes shorter when compared with that achieved in the case shown in FIG. 13, so that the chance of establishment of communication is enhanced.

A set value of the resonance frequency of the loop antenna 11 shown in FIG. 4 is 14.5 MHz. A horizontal axis in FIG. 4 represents a frequency; the center is located at 15.76 MHz; and one tick mark corresponds to 1 MHz. A vertical axis shown in FIG. 4 is identical with the vertical axis shown in FIG. 3. A left resonance point in the drawing represents a resonance point of the loop antenna 21, and a right resonance point in the drawing represents a resonance point of the loop antenna 11.

As shown in FIG. 4, the resonance point of the loop antenna 21 achieved when the resonance frequency of the loop antenna 11 is set to 14.5 MHz is about 12.8 MHz. When compared with the case shown in FIG. 3, the difference between the resonance frequency and the predetermined frequency (13.56 MHz) becomes further smaller, and the possibility of establishment of communication becomes further greater.

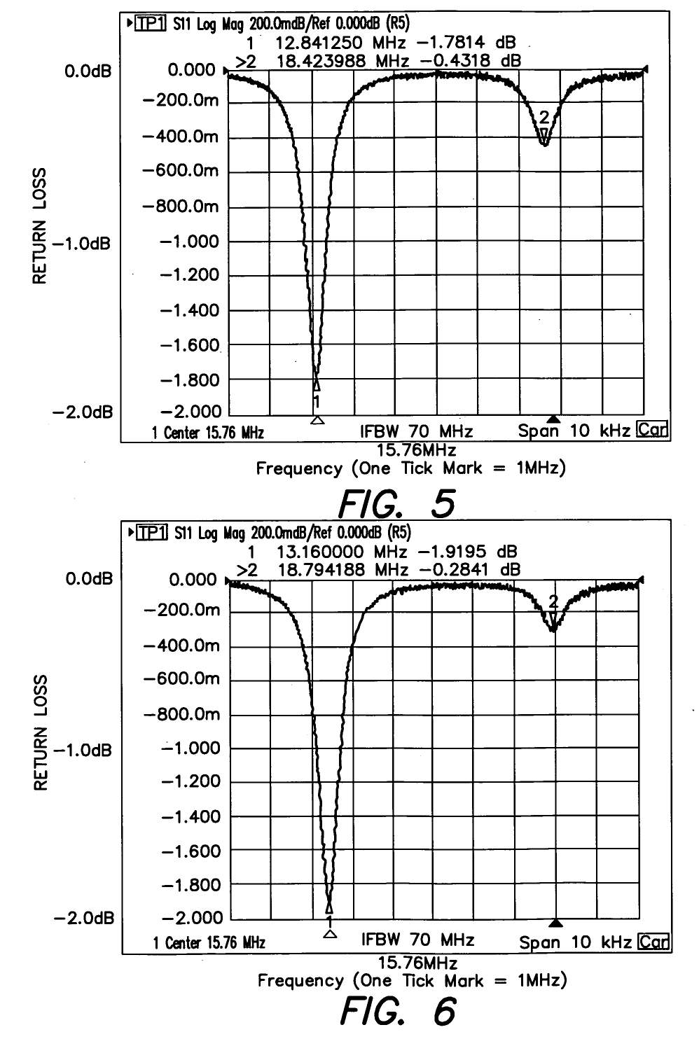

A set value of the resonance frequency of the loop antenna 11 shown in FIG. 5 is 15 MHz. A horizontal axis and a vertical axis shown in FIG. 5 are identical with their counterparts shown in FIG. 4. A left resonance point in the drawing represents a resonance point of the loop antenna 21, and a right resonance point in the drawing represents a resonance point of the loop antenna 11.

As shown in FIG. 5, the resonance point of the loop antenna 21 achieved when the resonance frequency of the loop antenna 11 is set to 15 MHz is about 12.9 MHz. When compared with the case shown in FIG. 4, the difference between the resonance frequency and the predetermined frequency (13.56 MHz) becomes further smaller, and the possibility of establishment of communication becomes further greater.

A set value of the resonance frequency of the loop antenna 11 shown in FIG. 6 is 15.5 MHz. A horizontal axis and a vertical axis shown in FIG. 6 are identical with their counterparts shown in FIG. 5. A left resonance point in the drawing represents a resonance point of the loop antenna 21, and a right resonance point in the drawing represents a resonance point of the loop antenna 11.

As shown in FIG. 6, the resonance point of the loop antenna 21 achieved when the resonance frequency of the loop antenna 11 is set to 15.5 MHz is about 13.2 MHz. When compared with the case shown in FIG. 4, the difference between the resonance frequency and the predetermined frequency (13.56 MHz) becomes further smaller, and the possibility of establishment of communication becomes further greater.

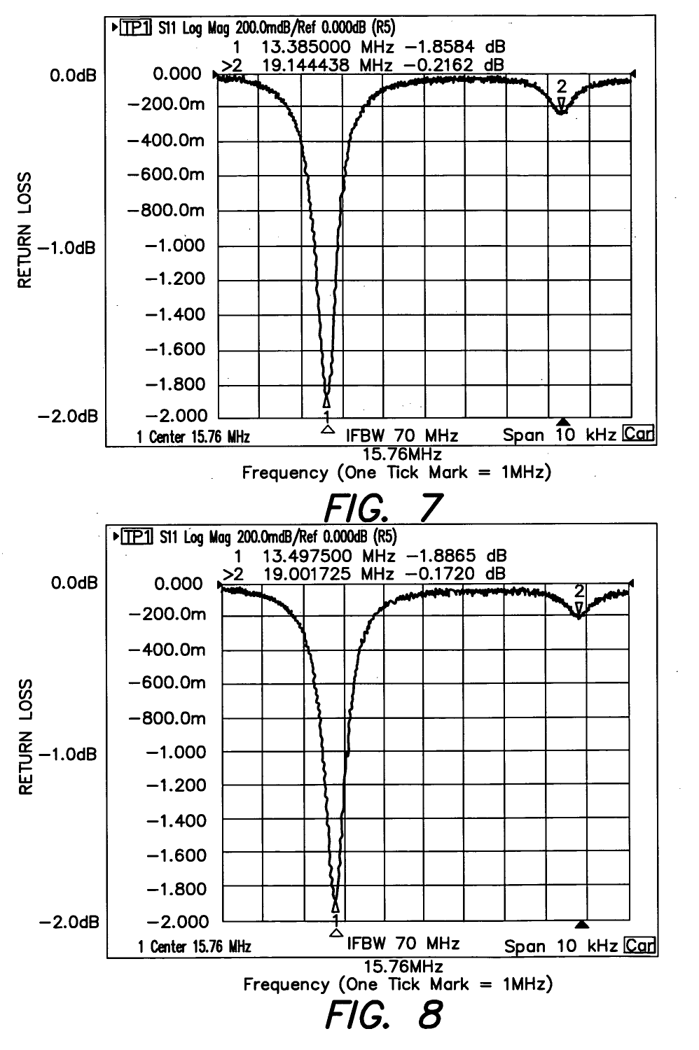

A set value of the resonance frequency of the loop antenna 11 shown in FIG. 7 is 16 MHz. A horizontal axis and a vertical axis shown in FIG. 7 are identical with their counterparts shown in FIG. 4. A left resonance point in the drawing represents a resonance point of the loop antenna 21, and a right resonance point in the drawing represents a resonance point of the loop antenna 11.

As shown in FIG. 7, the resonance point of the loop antenna 21 achieved when the resonance frequency of the loop antenna 11 is set to 16 MHz is about 13.4 MHz. When compared with the case shown in FIG. 6, the difference between the resonance frequency and the predetermined frequency (13.56 MHz) becomes further smaller, and the possibility of establishment of communication becomes further greater.

A set value of the resonance frequency of the loop antenna 11 shown in FIG. 8 is 16.5 MHz. A horizontal axis and a vertical axis shown in FIG. 8 are identical with their counterparts shown in FIG. 4. A left resonance point in the drawing represents a resonance point of the loop antenna 21, and a right resonance point in the drawing represents a resonance point of the loop antenna 11.

As shown in FIG. 8, the resonance point of the loop antenna 21 achieved when the resonance frequency of the loop antenna 11 is set to 16.5 MHz is about 13.5 MHz. When compared with the case shown in FIG. 7, the difference between the resonance frequency and the predetermined frequency (13.56 MHz) becomes further smaller, and the possibility of establishment of communication becomes further greater.

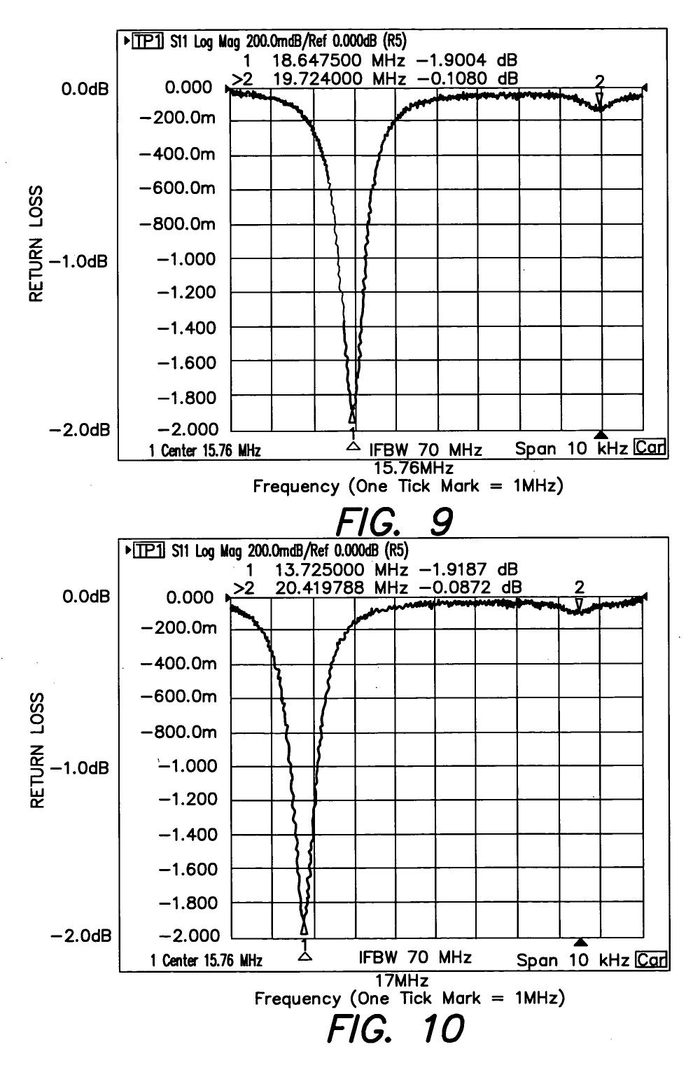

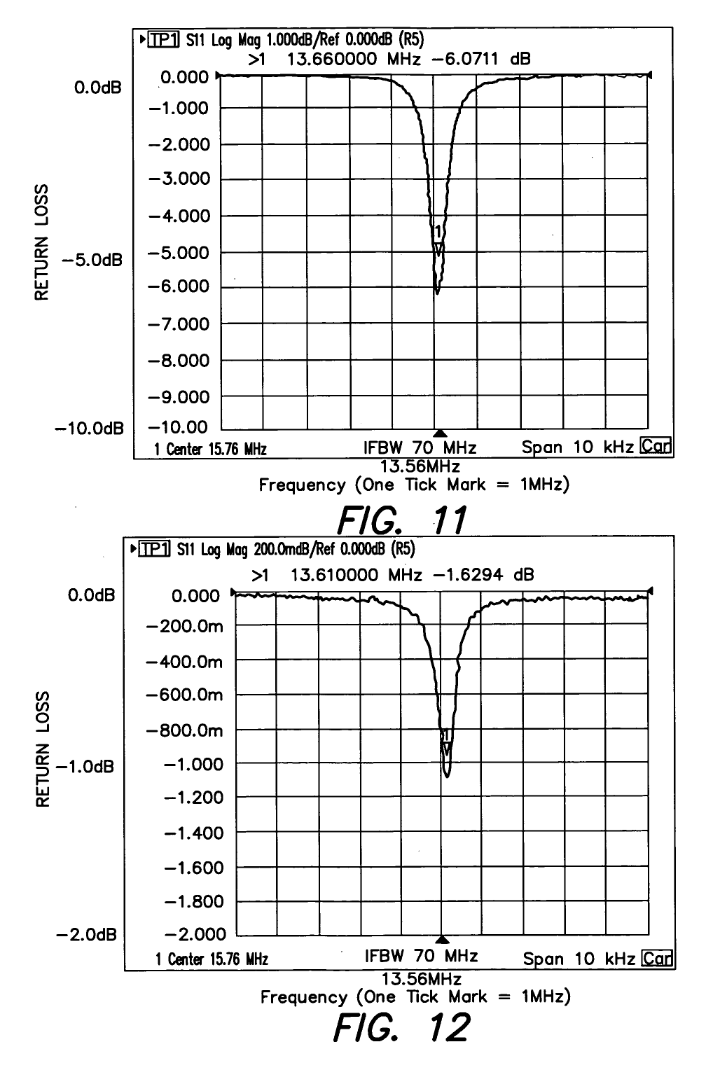

A set value of the resonance frequency of the loop antenna 11 shown in FIG. 9 is 17 MHz. A horizontal axis and a vertical axis shown in FIG. 9 are identical with their counterparts shown in FIG. 4. A left resonance point in the drawing represents a resonance point of the loop antenna 21, and a right resonance point in the drawing represents a resonance point of the loop antenna 11.

As shown in FIG. 9, the resonance point of the loop antenna 21 achieved when the resonance frequency of the loop antenna 11 is set to 17 MHz is about 13.7 MHz. The difference between the resonance frequency and the predetermined frequency (13.56 MHz) is nominally larger than that achieved in the case shown in FIG. 8, but the possibility of establishment of communication still remains high.

A set value of the resonance frequency of the loop antenna 11 shown in FIG. 10 is 17.5 MHz. A horizontal axis in FIG. 10 represents a frequency; the center is located at 17 MHz; and one tick mark corresponds to 1 MHz. A vertical axis shown in FIG. 10 is identical with the vertical axis shown in FIG. 4. A left resonance point in the drawing represents a resonance point of the loop antenna 21, and a right resonance point in the drawing represents a resonance point of the loop antenna 11.

As shown in FIG. 10, the resonance point of the loop antenna 21 achieved when the resonance frequency of the loop antenna 11 is set to 17.5 MHz is about 13.7 MHz. The difference between the resonance frequency and the predetermined frequency (13.56 MHz) is essentially the same as that achieved in the case shown in FIG. 9, but the possibility of establishment of communication still remains high.

As mentioned previously in connection with FIGS. 3 through 10, when the resonance frequency of the loop antenna 11 is set to a range from 16 MHz to 17 MHz, there is acquired a desirable result of the resonance point of the loop antenna 21 of the opposing noncontact IC card 20 coming closest to the predetermined frequency (13.56 MHz).

According to the foregoing embodiment of the present invention, when the predetermined frequency of radio communication established between the radio communication device 10 and the noncontact IC card 20 is 13.56 MHz and when the resonance frequency of the loop antenna 11 of the radio communication device 10 is set so as to fall within a range from 14 MHz to 18 MHz, communication is established while the resonance point of the loop antenna 21 of the noncontact IC card 20 is maintained in the vicinity of the predetermined frequency.

As described with reference to the embodiment, there is provided a radio communication device and a radio communication system that enable improvement of defective communication attributable to a frequency split arising as a result of a loop antenna of a card and a loop antenna of a reader/writer coming close to each other.

According to the embodiment, defective communications attributable to a frequency split resultant from loop antennas coming close to each other when the reader/writer is positioned opposite the noncontact IC card, are improved by adjusting the unique resonance frequency of the antenna of the reader/writer.

What is claimed is:

1. A radio communication device comprising:
an antenna that communicates with a non-contact IC card by a radio signal having a predetermined frequency, the antenna having an unique resonance frequency in vicinity of the predetermined frequency;
a frequency changer that shifts a resonance frequency of the antenna from the vicinity of the predetermined frequency to a high resonance frequency higher than the unique resonance frequency when the frequency changer is activated;
a controller that controls whether or not the frequency changer is activated.

2. The radio communication device according to claim 1, wherein the controller activates the frequency changer to shift the resonance frequency to the high resonance frequency when an operation mode is determined for communicating with the IC card.

3. The radio communication device according to claim 2, wherein the controller controls the frequency changer to communicate with another radio communication device as a non-contact IC card.

4. The radio communication device according to claim 1, wherein, when the predetermined frequency is 13.56 megahertz, the frequency changer shifts the resonance frequency to the high resonance frequency having a range from 14 megahertz to 18 megahertz.

5. A radio communication system comprising:
a non-contact IC card; and
a reader/writer device that establish communication with the non-contact IC cart by a radio signal having a predetermined frequency while opposing each other;
wherein the reader/writer has:
an antenna that has an unique resonance frequency;
a frequency changer that shifts the resonance frequency from the vicinity of the predetermined frequency to a high resonance frequency higher than the unique resonance frequency when the frequency changer is activated;
a controller that controls whether or not the frequency changer is activated.

6. The radio communication system according to claim 5, wherein the controller activates the frequency changer to shift the resonance frequency to the high resonance frequency when an operation mode is determined for communicating with the IC card.

7. The radio communication system according to claim 6, wherein the controller controls the frequency changer to communicate with another radio communication device as a non-contact IC card.

8. The radio communication system according to claim 5, wherein, when the predetermined frequency is 13.56 megahertz, the frequency changer shifts the resonance frequency to the high resonance frequency having a range from 14 megahertz to 18 megahertz.

9. A control method for a radio communication device comprising:
communicating with a non-contact IC card by a radio signal having a predetermined frequency by using an antenna having an unique resonance frequency in vicinity of the predetermined frequency;
shifting a resonance frequency of the antenna from the vicinity of the predetermined frequency to a high resonance frequency higher than the unique resonance frequency;
controlling whether or not the resonance frequency is shifted.

10. The control method according to claim 9, wherein the resonance frequency is changed to the high resonance frequency when an operation mode is determined for communicating with the IC card.

11. The control method according to claim 10, wherein the resonance frequency is changed for communicating with another radio communication device as a non-contact IC card, when the operation mode is determined for communicating with another radio communication device as a non-contact IC card.

12. The control method according to claim 9, wherein, when the predetermined frequency is 13.56 megahertz, the resonance frequency is changed to the high resonance frequency having a range from 14 megahertz to 18 megahertz.

13. The radio communication device according to claim 1, wherein the frequency changer include a reactance element to shift the resonance frequency from the vicinity of the predetermined frequency to the high resonance frequency.

14. The radio communication system according to claim 5, wherein the frequency changer include a reactance element to shift the resonance frequency from the vicinity of the predetermined frequency to the high resonance frequency.
